(19) United States
(12) Patent Application Publication
(10) Pub. No.: US 2003/0028657 A1
(43) Pub. Date: Feb. 6, 2003

(54) Directly addressed multicast protocol

(76) Inventors: Gary L. Thunquest, Berthoud, CO (US); Jeffrey D. Schwartz, Loveland, CO (US)

Correspondence Address: HEWLETT-PACKARD COMPANY, Intellectual Property Administration, P.O. Box 272400, Fort Collins, CO, 80527-2400, US

(21) Appl. No.: 09/919,108

(22) Filed: Jul. 31, 2001

(51) Int. Cl. G06F 15/16

(52) U.S. Cl. 709/230; 709/245

(57) ABSTRACT

A system and a method for transmitting data packets over a network to selected multiple remote destinations. The data packets include a header section and a data section. The header section includes a special internetworking protocol field indicating that a list of internetworking protocol addresses is embedded in the data packet. Network elements utilize a particular addressing protocol to access the list of addresses and transmit a copy of the data packet to each of the selected remote destinations corresponding to each of the addresses in the list.

### TECHNICAL FIELD

This invention relates to a new internetworking protocol (IP) multicast protocol that will be useful for implementing networked storage.

### BACKGROUND ART

Existing IP multicast technology works by having the sending systems address a packet of data to a unique multicast address, which is then routed by the network infrastructure to each of the remote destinations that have expressed a desire to receive the data packet. As such, the destinations for the IP multicast data packets are unknown to the sender. This model of addressing is useful for the most prevalent use of the current IP multicast scheme, streaming multimedia.

In existing IP multicast protocols, the sender sends a data packet to a single virtual multicast address, where the actual recipients are determined by a subscription process managed by a network of switches and routers. There are two alternatives in the existing art for accomplishing multicast data transmission over an IP network: (1) sending multiple singly-addressed packets, one to each of the remote destinations; and (2) setting up a multicast group in the network switch, sending the multicast packet, and then deleting the multicast group. The first alternative results in a significant load on the sending system and on the network infrastructure connected to it. The second alternative results in an increased burden on the network switches. A need exists for an improved method of sending multicast data packets.

### SUMMARY OF INVENTION

The present invention uses an enhanced addressing model for IP multicast protocols. In one respect, what is described is a method for transmitting data packets over a network to selected multiple remote destinations wherein the data packets do not travel over any segment of the network more than once and the selected multiple remote destinations are not required to initiate delivery of the data packets through a subscription service. The method includes the following steps: embedding in a data packet a list of multiple remote destination addresses corresponding to each of the selected multiple remote destinations; providing an addressing protocol by which networking elements are capable of accessing the list of multiple remote destination addresses; and instructing the networking elements to transmit a copy of the data packet to each of the selected multiple remote destinations corresponding to each of the addresses in the list of multiple remote destination addresses.

In another respect, what is described is a system for transmitting data packets over a network to selected multiple remote destinations wherein the data packets do not travel over any segment of the network more than once and the selected multiple remote destinations are not required to initiate delivery of the data packets through a subscription service. The system includes: a directly addressed multicast protocol (DAMP) client; a network infrastructure; multiple network devices remotely located from the DAMP client and the network infrastructure; and data packets for carrying data between the DAMP client and the multiple network devices.

In yet another respect, what is described is a computer-readable medium on which is embedded a program. The embedded program includes instructions for executing the above method.

Those skilled in the art will appreciate these and other advantages and benefits of various embodiments of the invention upon reading the following detailed description of an embodiment with reference to the below-listed drawings.

### BRIEF DESCRIPTION OF DRAWINGS

FIG. 1 is a block diagram of a system for delivering multicast data packets over a network according to the prior art;

FIG. 2 is a block diagram of one embodiment of a system for transmitting data packets over a network to selected multiple remote destinations according to the present invention;

FIG. 3 is a block diagram of another embodiment of a system for transmitting data packets over a network to selected multiple remote destinations according to the present invention;

FIG. 4 is a flowchart of one embodiment of a method for transmitting data packets over a network to selected multiple remote destinations;

FIG. 5 is a diagram of one embodiment of the structure of a directly addressed multicast protocol data packet according to the present invention;

FIG. 6 is a diagram of one embodiment of the structure of an IP options field within a directly addressed multicast protocol data packet according to the present invention;

FIG. 7 is a diagram illustrating a path of one embodiment of a directly addressed multicast protocol data packet through the Internet to multiple destinations; and

FIG. 8 is a diagram illustrating another path of one embodiment of a directly addressed multicast protocol data packet through the Internet to multiple destinations.

### DETAILED DESCRIPTION

The present invention relates to a new IP multicast protocol hereinafter referred to as Directly Addressed Multicast Protocol (DAMP). In a DAMP system, a sending client specifies a list of remote destinations directly for each data packet being sent. The term DAMP is used as a label only, and other terms can define the same or similar protocols.

Using DAMP, a network of switches and routers will continue to resend the data packets over only those network segments that contain a route to at least one of the specified remote destination addresses. This method thus does not generate unnecessary traffic on any network segment. This form of multicast also greatly simplifies the multicast process by removing the need for multicast group management protocols to manage the destination lists within the network infrastructure. The list of remote destinations are embedded in each data packet, rather than being persistent within the network infrastructure.

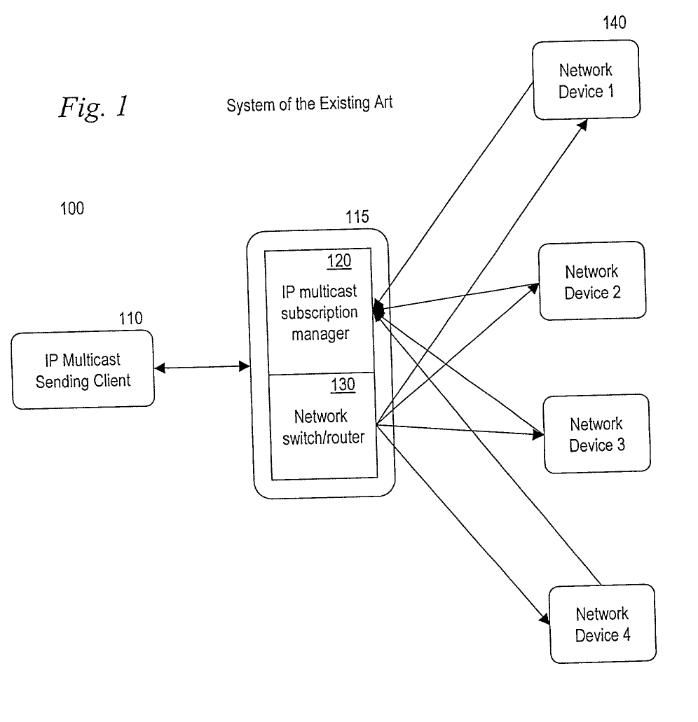

FIG. 1 is a block diagram of a system 100 for delivering multicast data packets over a network according to the prior art. In the existing art covering IP multicast protocols, the system 100 includes at least one IP multicast sending client 110 connected to and communicating with a network infrastructure 115. The IP multicast sending client 110 sends IP multicast data packets out to the network infrastructure 115. Within the network infrastructure 115, at least one IP multicast subscription manager 120 is further connected to and communicating with a number of network devices 140. The IP multicast subscription manager 120 receives requests from the network devices 140 to subscribe to multicast data transmissions from the IP multicast sending client 110. When the IP multicast sending client 110 sends IP multicast data packets out to the network infrastructure 115, the IP multicast subscription manager 120 determines which of the network devices 140 have subscribed to those particular data packets. Alongside the IP multicast subscription manager 120 within the network infrastructure 115 are a number of network switches and routers 130. Upon a determination of which network devices 140 are subscribed to the data packets being transmitted from the IP multicast sending client, the network switches and routers 130 forward copies of the data packets to each of the network devices 140 subscribed to the data packets, and await receipt acknowledgments from the network devices 140. The network infrastructure 115 may resend data packets until all data packets are confirmed received by all network devices 140. As a result of this multicast scheme, the data packets may travel over any given network segment many times, multiplying the load on the network bandwidth.

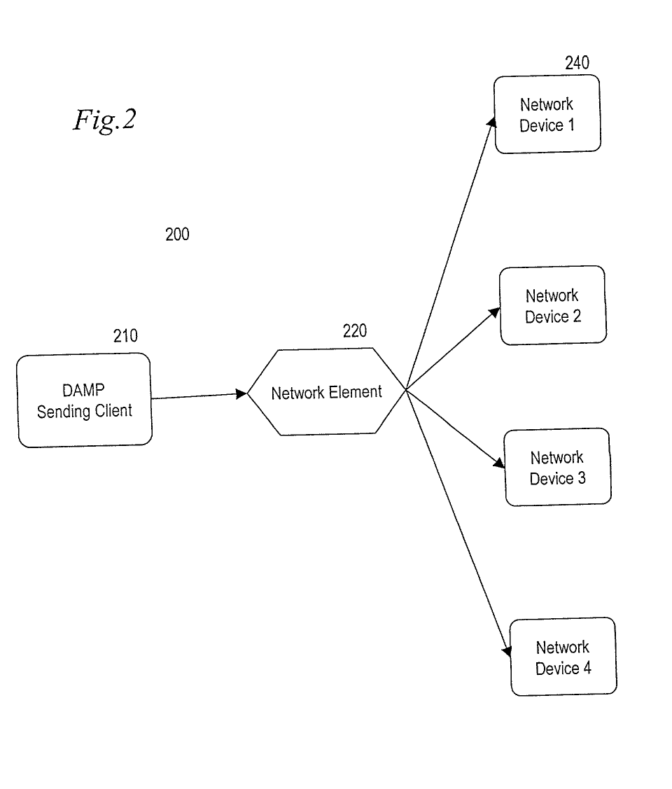

FIG. 2 is a block diagram of one embodiment of a system 200 according to the present invention for transmitting data packets over a network to selected multiple remote destinations. The system 200 of the present invention includes a DAMP sending client 210 which is connected to one or more network elements 220. The DAMP sending client 210 transmits DAMP data packets to the network elements 220. A network element 220 may be a network switch or router and is a part of the overall network infrastructure 115, as described for FIG. 1. However, unlike existing multicast systems 100, the present invention does not require an IP multicast subscription manager 120 to manage requests for subscriptions to multicast data transmissions and to manage lists of requesting network devices 140. The system 200 of an embodiment of the present invention includes a number of remote network devices 240. In the present invention, a list of selected remote network devices 240 that are to receive the DAMP multicast transmission is embedded in the DAMP data packets themselves. The network elements 220 route the DAMP data packets on to the selected remote network devices 240 determined in the list embedded in the DAMP data packets. In the system 200, it is not necessary for the DAMP data packets to travel over any given network segment more than once, thus reducing the load on the bandwidth of the network.

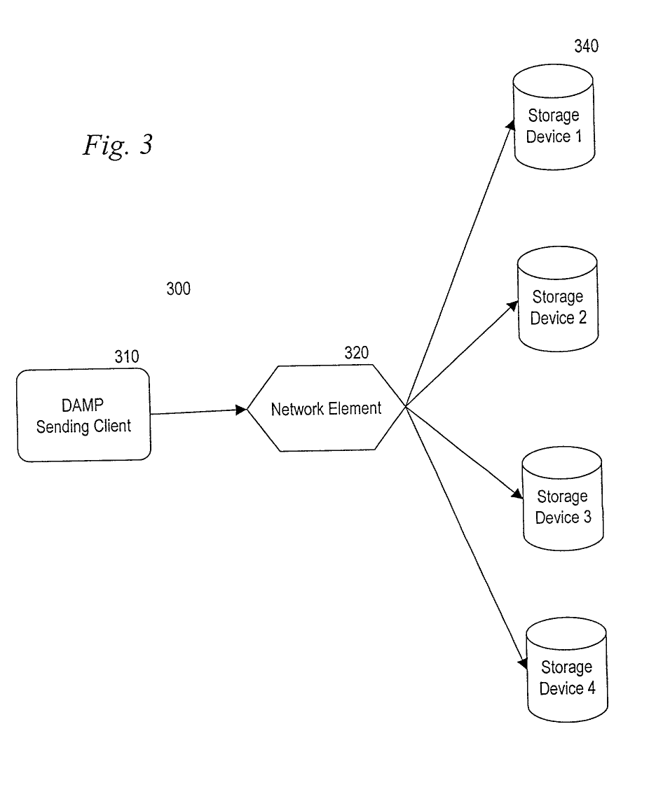

FIG. 3 is a block diagram of another embodiment of a system 300 for transmitting data packets over a network to selected multiple remote destinations according to the present invention. The system 300 illustrates the use of the present invention in a network storage application. The system 300 includes a DAMP sending client 310 connected to one or more network elements 320. The DAMP sending client 310 transmits DAMP data packets to the network elements 320. As with the network elements 220 of the system 200, the network elements 320 may include network switches, routers, or other network infrastructure elements. The network elements 320 are connected to a number of remote network storage devices 340. As with the embodiment described for FIG. 2, in the system 300, a list of selected remote network storage devices 340 that are to receive the DAMP multicast transmission is embedded in the DAMP data packets. The network elements 320 route the DAMP data packets on to the selected remote network storage devices 340 determined in the list embedded in the DAMP data packets.

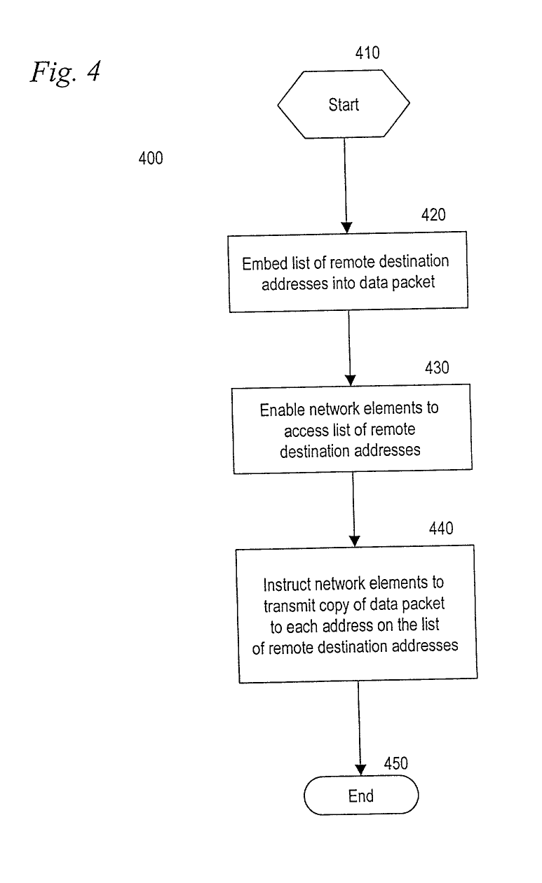

FIG. 4 is a flowchart of one embodiment of a method 400 for transmitting data packets over a network to selected multiple remote destinations. The method 400 includes the steps of: embedding a list of remote destination addresses into data packets (step 420); enabling network elements to access the list of remote destination addresses (step 430); and instructing network elements to transmit copies of the data packets to each address on the list of remote destination addresses (step 440).

In one embodiment of the method 400, the embedding step 420 includes the additional steps of: setting up an IP Options field within the IP header section of a DAMP data packet; setting a Code byte within the IP Options field to a specific value to indicate that the data packet is a DAMP data packet; setting a Length byte to a determinable value to indicate the length in 32-bit words of the IP Options field; embedding in successive 32-bit words the values of a determinable number of IP addresses for the multiple remote destinations for the DAMP data packet; and setting the source IP address in the header section of the DAMP data packet to the IP address of the DAMP sending client 210; and setting the destination IP address in the IP header section of the DAMP data packet to the IP address of one of the multiple remote destinations embedded in the IP Options field. In this embodiment of the method 400, the copying step 440 further includes the steps of: the network element 220 receiving a copy of the DAMP data packet from the DAMP sending client 210 or from another network element 220; the network element 220 zeroing those IP addresses embedded in the IP Options field that are not directly accessible below the network element 220; the network element 220 setting the destination IP address in the IP header section of the DAMP data packet to the IP address of one of the non-zeroed multiple remote destinations embedded in the IP Options field; and the network element 220 routing a copy of the modified DAMP data packet to each additional network element 220 or network device 240 for which there is a corresponding non-zeroed IP address listed in the embedded list of multiple remote destination IP addresses.

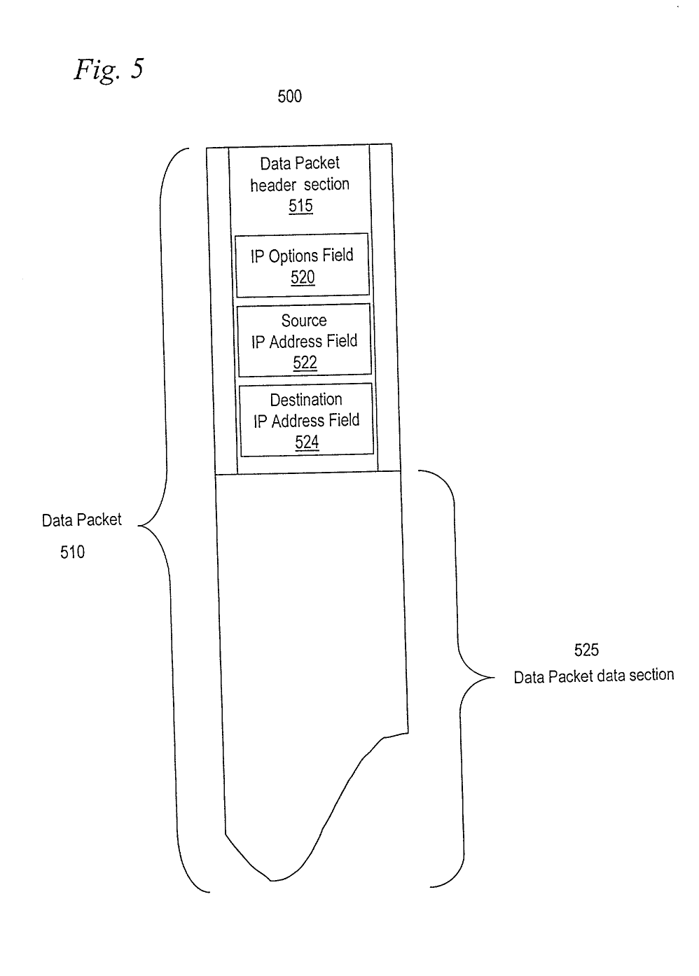

FIG. 5 is a diagram of the structure 500 of one embodiment of a DAMP data packet 510 according to one embodiment of the present invention. The data packet structure 500 includes a data packet header section 515 and a data packet data section 525.

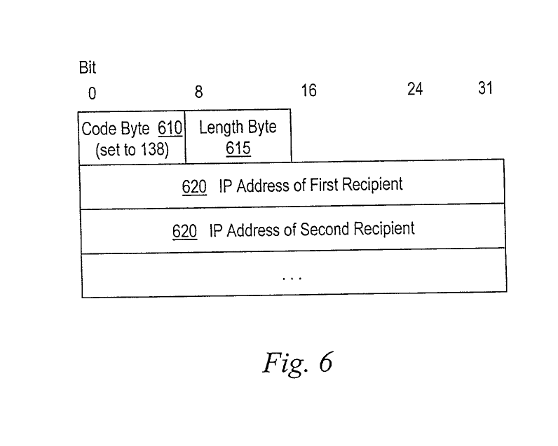

The data packet header section 515 contains multiple fields, one of which is a variable length field containing certain IP options information, an IP options field 520. FIG. 6 is a diagram of one embodiment of the structure of an IP options field 520 within a directly addressed multicast protocol data packet 510 according to the present invention. The variable length IP options field 520 comprises a sequence of items, each of which start with a Code byte 610 comprised of the following bits, where bit 0 is considered the Most Significant Bit (“MSB”):

Bit 0—Copy bit—which defines whether the IP options field 520 should be copied into each network fragment if the data packet 510 is fragmented, or split, across multiple network frames. A value of 0 indicates that the IP options field 520 should be copied into only the first frame, whereas a value of 1 indicates that the IP options field 520 should be copied into every frame;

Bits 1-2—Option class—which defines a set of IP class values;

Bits 3-7—Option number—these bits identify the specific IP option for this data packet, where each of the available IP options is associated with a unique Option number.

An IP data packet 510 may be encoded with DAMP using an IP option Code byte 610 which in one embodiment may be set to a value of 138. Other values for the IP option Code byte 610 may be equally possible. A Code byte 610 value of 138 corresponds to setting the Copy bit to 1, the Option class to 0, and the option number to 10, where 10 is one of the currently unused values for IP option numbers. The Option number may alternatively be any currently unused IP option value.

Following the Code byte 610 in the encoding of the DAMP data packet IP options field 520, the structure of a DAMP data packet header section 515 may follow a pattern similar to that of the existing Strict Route IP Option, which is currently assigned to IP Option number 137. See Comer, Douglas E., Internetworking with TCP/IP—Principles, Protocols, and Architecture, 4th Ed., Vol. 1, Prentiss Hall, February 2000, pp.97-114.

The IP options field 520 is broken down into multiple 32-bit words, as shown in FIG. 6. The first word of the IP options field 520 contains the 8-bit (one byte) Code byte 610, set to a value of 138 for DAMP data packets, and the Length byte 615, which contains a value specifying the number of bytes in the IP options field 520 (including the code and length bytes 610 and 615). This word is followed by multiple IP address fields 620, each containing four-byte IP addresses for each of the intended recipients of the DAMP data packet 510, the remote network devices 240. There may be as many IP address fields 620 as allowed for by the value specified in the Length byte 615. For example, if the Length byte 615 indicates that the IP options field 520 includes 32 bytes, then the IP options field 520 contains seven 32-bit (four-byte) IP address fields 620, in addition to the first word containing the Code byte 610 and the Length byte 615. The data packet header section 515 may also include two other fields of interest: a source IP address field 522, specifying the IP address of the DAMP sending client 210, and a destination IP address field 524, specifying the IP address of one of the remote network devices 240. In an alternative embodiment, the IP address fields 620, the source IP address field 522, and the destination IP address field 524 may each comprise multi-byte IP addresses of a type other than four-byte addresses.

The data packet data section 525 is encoded following a standard User Datagram Protocol (“UDP”) IP data packet encoding scheme. As a connectionless protocol which, like TCP, is layered on top of IP, UDP neither guarantees delivery nor does it require a connection. As a result, it is lightweight and efficient, but all error processing and retransmission must be taken care of by the application program. See Postel, Jon, User Datagram Protocol, RFC 768, Network Information Center, SRI International, Menlo Park, Calif., August 1980.

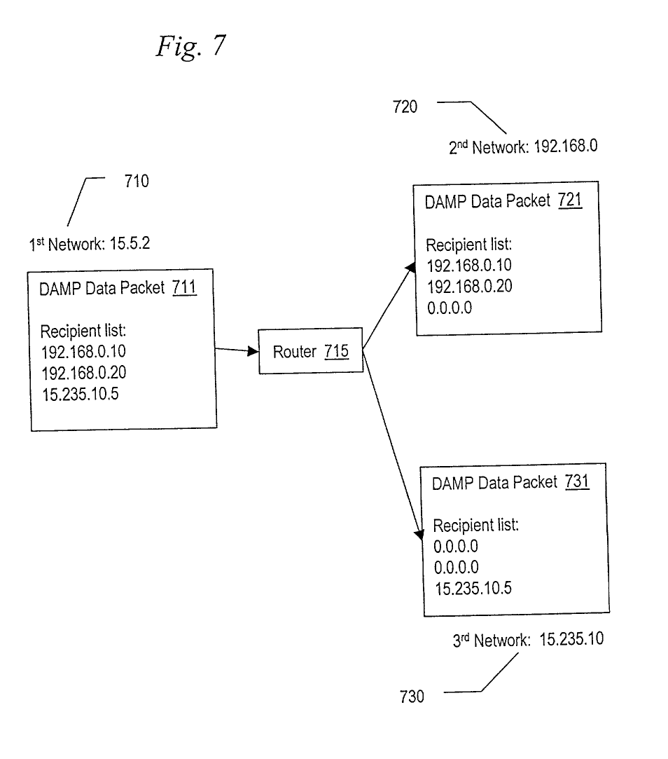

FIG. 7 shows an exemplary path of one embodiment of a DAMP encoded data packet 711 through the Internet to multiple destination remote network devices 240. When a DAMP sending client 210 sends a DAMP data packet 711, it sets the source IP address 522 contained in the data packet header section 525 to the IP address of the DAMP sending client 210 itself, and the destination IP address 524 to any of the IP addresses of the remote network devices 240 intended to receive the data packet. The DAMP sending client 210 further encodes the data packet 711 with an IP Options field 520 containing the value for the DAMP IP Option, as described above, and which contains a list of each of the desired destination remote network device 240 IP addresses. The data packet data section 525, or UDP-encoded data portion of the data packet, thus remains unchanged from that of a standard UDP data packet which may be sent to any single recipient under existing IP transmission protocols.

When a router (or network switch) 715 receives a DAMP data packet 711, which a router or switch may recognize from the DAMP IP Option encoded into the data packet 711, it will ignore the destination IP address 524, and instead examine the list of IP addresses contained in the DAMP IP Options field 520. The router 715 then sends a copy to each network interface 720 and 730 that contains at least one recipient as specified in the address list in the IP Options field 520. However, before sending the data packets 721 and 731 on to a network interface, such as the network interfaces 720 and 730 shown, each IP address in the IP Options field 520 list that is not intended to eventually receive that copy of the data packet, i.e., is not found on a branch of that specific network interface, is zeroed out. This prevents the creation of an infinite number of data packets sent by two interconnected routers or switches addressing hosts existing across more than one network interface. Furthermore, the switch or router 715 will set the destination IP address 524 in the IP header section 515 to one of the non-zero entries remaining in the recipient list (and the corresponding frame header destination hardware address). When a DAMP data packet 721 or 731 is received with zeroed addresses in it, the zeroed addresses are ignored. Entries are zeroed out rather than removing them in order that the router or switch does not have to reformat the data packet.

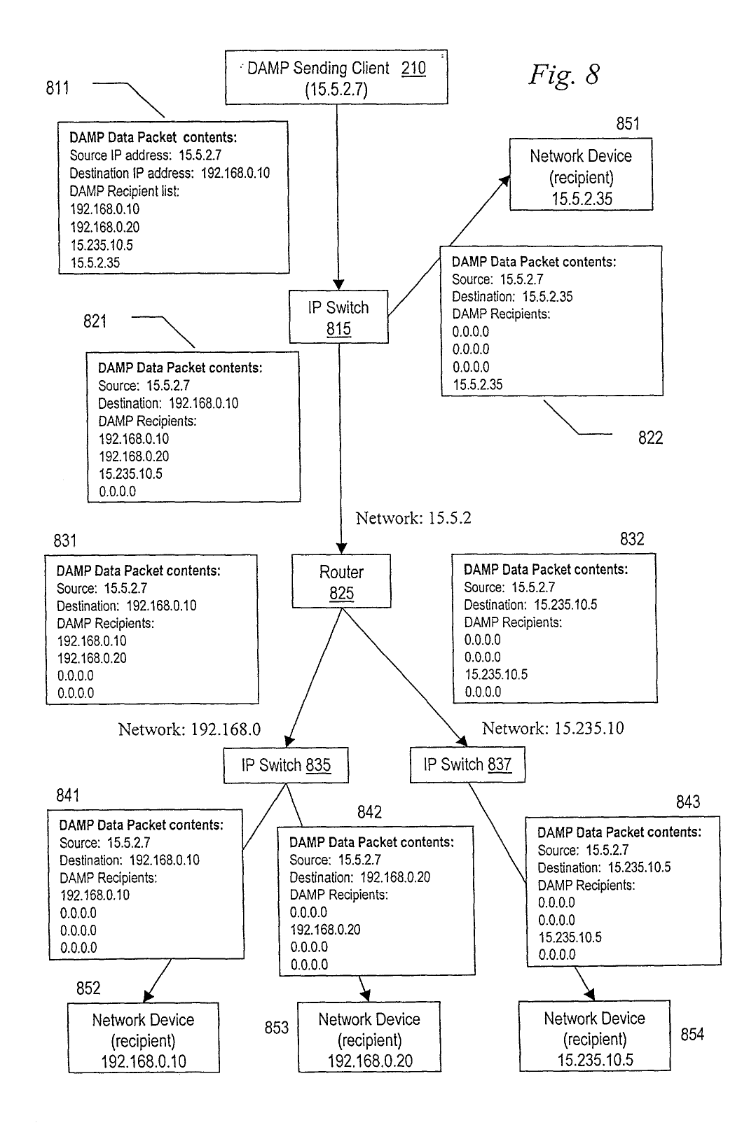

FIG. 8 is a diagram showing how a network of DAMP enabled routers and switches would pass a DAMP data packet through several branches of the network. Exemplary values for the relevant fields embedded in each successive copy of the DAMP data packet are shown as it travels across each network segment. This figure shows how in one embodiment of the invention, a network element 220, such as a router or IP switch (815, 825, 835, 837), upon receiving a copy of the DAMP data packet 510 (811, 821, 831, 832) from the DAMP sending client 210 or from another network element (815, 825, 835, 837), then processes a copy of the received DAMP data packet (811, 821, 831, 832) by zeroing those IP addresses embedded in the IP Options field 520 that are not directly accessible below the network element (815, 825, 835, 837); setting the destination IP address 524 in the IP header section 525 of the copy of the DAMP data packet (821, 822, 831, 832, 841, 842, 843) to the IP address of one of the non-zeroed remote destination network devices (851, 852, 853, 854) embedded in the IP Options field 520; and routing the modified copy of the DAMP data packet (821, 822, 831, 832, 841, 842, 843) to each additional network element (825, 835, 837) or network device (851, 852, 853, 854) for which there is a corresponding non-zeroed IP address listed in the embedded list of multiple remote destination IP addresses.

When a remote network device 240 receives a DAMP data packet, it can process it like any other UDP data packet. In fact, no DAMP software is necessary on the remote network devices 240 beyond the normal UDP software necessary to receive the data packet. In an alternate embodiment, the remote network device's 240 network element 220 could be programmed or otherwise adapted to be DAMP aware such that the network element 220 could examine the list of addresses contained in the DAMP IP Options field 520 to determine if the DAMP data packet 510 was intended for that network element 220. This would remove the need for switches and routers to set the destination IP address 524 to a recipient IP address (which may be impractical for network elements 220 to do without duplicating the data packet 510 and sending a copy of the data packet 510 for each recipient address to every network device 240 attached to it).

An alternative embodiment of DAMP data packet encoding may store destination port numbers within the recipient list along with the IP addresses. Routers and switches could then set the port numbers within the UDP header in the IP data section of the DAMP data packet. This alternative embodiment may eliminate one potential limitation of the DAMP encoding scheme whereby it is otherwise assumed that the destination port number is identical for each recipient host.

The method 400, shown in FIG. 4, is better understood in conjunction with the diagram of the structure 500 of a DAMP data packet 510, as shown in FIG. 5, and the diagram of one embodiment of the structure of an IP options field 520 within a directly addressed multicast protocol data packet 510, as shown in FIG. 6.

The method 400 operates by embedding (step 420) multiple IP address fields 620 into the header section 515 of a DAMP data packet 510. Additionally, the method 400 provides a scheme (step 430) by which network elements 220, such as network routers or switches, may access the list of multiple IP address fields 620. One embodiment of the present invention places a uniquely formatted IP options field 520 in the IP header section 515 of the DAMP data packet 510. The IP options field 520, by way of a specific value assigned to a Code byte 610 within the IP Options field 520, signifies that the data packet 510 is a DAMP data packet and thereby indicates that a list of multiple IP address fields 620 is embedded in the IP header section 515 of the DAMP data packet 510. The IP options field 520 may then be read and translated (step 430) by network elements 220 and the list of multiple IP address fields 620 embedded in the IP header section 515 of the DAMP data packet 510 may then be accessed and read. The network elements 220 then transmit (step 440) copies of the DAMP data packet 510 to each of the addresses in the list of multiple IP address fields 620.

The present invention improves on existing multicast protocols in one respect by not consuming bandwidth on a network segment to send the same data twice. This results in lower network utilization and improved network performance. DAMP further improves on existing multicast protocols by not requiring the overhead of setting up and deleting multicast groups in the network switch, independent of the data packets, and by not requiring a subscription service for the transmission of multicast data. This also results in lower network utilization and improved performance.

For one embodiment of the present invention, a comparison may be made, outside the unique DAMP addressing model and multicast behavior, between the network effects of DAMP and the well known Unreliable Datagram Protocol (“LUDP”), in contrast to the Transmission Control Protocol (“TCP”). This analogy may be drawn where the embodiment of the present invention does not require confirmation of receipt of the DAMP data packets by the remote network devices to be sent back to the DAMP sending client before continuing with transmission of additional DAMP data packets, as in UDP. This embodiment substantially reduces the load on the network.

In another embodiment of the present invention, confirmation of receipt of the DAMP data packets by the remote network devices is required to be sent back to the DAMP sending client, similar to the manner in which TCP operates. This embodiment requires bidirectional transmission of data, resulting in a correspondingly lesser decrease in network traffic than the embodiment described above.

One potential use identified for DAMP is in networked storage systems. DAMP allows data clients to send data directly to storage elements, and enables the data clients to arrange the data in striped and mirrored configurations across numerous remote storage elements, each with their own unique IP addresses, without the need for multicast subscription management elements within the network infrastructure. DAMP allows the client to efficiently and dynamically, with no unnecessary overhead, deliver data to the appropriate remote storage elements.

The steps of the method 400 can be implemented with hardware or by execution of programs, modules or scripts. The programs, modules or scripts can be stored or embodied on one or more computer readable mediums in a variety of formats, such as source code, object code or executable code, for example. The computer readable mediums may include, for example, both storage devices and signals. Exemplary computer readable storage devices include conventional computer system RAM (random access memory), ROM (read only memory), EPROM (erasable, programmable ROM), EEPROM (electrically erasable, programmable ROM), and magnetic or optical disks or tapes. Exemplary computer readable signals, whether modulated using a carrier or not, are signals that a computer system hosting or running the described methods can be configured to access, including signals downloaded through the Internet or other networks.

The terms and descriptions used herein are set forth by way of illustration only and are not meant as limitations. Those skilled in the art will recognize that many variations are possible within the spirit and scope of the invention as defined in the following claims, and their equivalents, in which all terms are to be understood in their broadest possible sense unless otherwise indicated

What is claimed is:

1. A method for transmitting data packets over a network to selected multiple remote destinations, the method comprising the steps of:
embedding in a first data packet a list of multiple remote destination addresses corresponding to each of the selected multiple remote destinations;
providing an addressing protocol by which networking elements are capable of accessing the list of multiple remote destination addresses; and
instructing networking elements to transmit a copy of the first data packet to each of the selected multiple remote destinations corresponding to each of the addresses in the list of multiple remote destination addresses.

2. The method of claim 1, further comprising using the network elements to transmit the data packets without having the data packets travel over any segment of the network more than once.

3. The method of claim 2, further comprising transmitting the data packets to the selected multiple remote destinations without using a subscription service to initiate delivery of the data packets.

4. The method of claim 1 wherein the embedding step comprises using internetworking protocol (IP) data packets.

5. The method of claim 1 further comprising including network storage devices in the list of selected multiple remote destinations.

6. The method of claim 1 wherein the instructing step further comprises:
instructing network switches or routers receiving the first data packet to copy the first data packet into one or more second data packets, wherein copying the first data packet comprises:
creating one or more second data packet copies of the received first data packet;
zeroing out each IP address in the list of selected multiple remote destinations that is not directly accessible beyond the network switch or router receiving the first data packet; and
setting a destination IP address field in each second data packet to one of the non-zeroed IP addresses in the list of selected multiple remote destinations in the second data packet; and
transmitting the one or more second data packets to the directly accessible remote destination or network element indicated for each non-zeroed IP address in the list of selected multiple remote destinations embedded in the one or more second data packets.

7. A system for transmitting data packets over a network to selected multiple remote destinations, the system comprising:
a directly addressed multicast protocol (DAMP) client;
a network infrastructure;
multiple network devices remotely located from the DAMP client and the network infrastructure; and
data packets for carrying data between the DAMP client and the multiple network devices.

8. The system of claim 7 wherein the data packets do not travel over any segment of the network more than once.

9. The system of claim 8 wherein the selected multiple remote destinations do not initiate delivery of the data packets through a subscription service.

10. The system of claim 7 wherein the network infrastructure further comprises network switches and routers.

11. The system of claim 7 wherein the data packets comprise internetworking protocol (IP) data packets.

12. The system of claim 7 wherein the multiple network devices include network storage devices.

13. A computer readable medium on which is embedded a program, the program comprising modules that execute a method for transmitting data packets over a network to selected multiple remote destinations, the method comprising the steps of:
embedding in a first data packet a list of multiple remote destination addresses corresponding to each of the selected multiple remote destinations;
providing an addressing protocol by which networking elements are capable of accessing the list of multiple remote destination addresses; and
instructing networking elements to transmit a copy of the first data packet to each of the selected multiple remote destinations corresponding to each of the addresses in the list of multiple remote destination addresses.

14. The computer readable medium of claim 13, further comprising using the network elements to transmit the data packets without having the data packets travel over any segment of the network more than once.

15. The computer readable medium of claim 14, further comprising transmitting the data packets to the selected multiple remote destinations without using a subscription service to initiate delivery of the data packets.

16. The computer readable medium of claim 13 wherein the embedding step comprises using internetworking protocol (IP) data packets.

17. The computer readable medium of claim 13, further comprising including network storage devices in the list of selected multiple remote destinations.

18. The computer readable medium of claim 13 wherein the instructing step further comprises:
instructing network switches or routers receiving the first data packet to copy the first data packet into one or more second data packets, wherein copying the first data packet comprises:
creating one or more second data packet copies of the received first data packet;
zeroing out each IP address in the list of selected multiple remote destinations that is not directly accessible beyond the network switch or router receiving the first data packet; and
setting a destination IP address field in each second data packet to one of the non-zeroed IP addresses in the list of selected multiple remote destinations in the second data packet; and
transmitting the one or more second data packets to the directly accessible remote destination or network element indicated for each non-zeroed IP address in the list of selected multiple remote destinations embedded in the one or more second data packets.
